(19) United States
(12) Patent Application Publication
(10) Pub. No.: US 2007/0235212 A1
(43) Pub. Date: Oct. 11, 2007

(54) Wiring harness

(76) Inventors: Heath A. Waldorf, Hoboken, NJ (US); Sean Smith, Lake Hopatcong, NJ (US)

Correspondence Address: BINGHAM MCCUTCHEN LLP, 2020 K Street, N.W., Intellectual Property Department, WASHINGTON, DC, 20006, US

(21) Appl. No.: 11/397,639

(22) Filed: Apr. 5, 2006

(51) Int. Cl. H01B 17/32

(52) U.S. Cl. 174/209

(57) ABSTRACT

A wiring harness that is protected against damage caused by exposure to ultraviolet light is disclosed and claimed. The harness may be constructed out of two pieces that may be joined together, and may also be mounted against a surface, and its structure and design may be altered to minimize aesthetic impact of the structure upon which it is mounted.

### BACKGROUND OF THE INVENTION

1. Field of the Invention

The present invention generally relates to a wiring harness that is protected from external environmental damage, for example, from ultraviolet light exposure in an outdoor setting.

2. Description of the Related Art

Wiring harnesses are a staple of modern cable placement and construction. They are often used to secure wires, protecting them and hiding them from sight. Conventional uses include, for example, hiding a television power cable in a residence or directing wires away from areas in which it would be undesirable to have an exposed or viewable cable. The harness itself, in addition to its functional purpose, may also be designed for minimal aesthetic impact. Additionally, a wiring harness may be employed in an outdoor setting, for example, to secure cable against the side of a building.

Wiring harnesses used in outdoor settings are exposed to various environmental factors that have a negative impact upon their performance. Constant exposure to outdoor conditions may make a wiring harness brittle and prone to breakage, or such exposure may compromise the integrity of the wire contained within the harness. One of the most pervasive conditions to which a wiring harness is exposed is ultraviolet light, prolonged exposure to which may have a detrimental effect on plastics and other materials that are often used to construct outdoor wiring harnesses, potentially compromising the integrity of the enclosed wire or cable. Thus, there exists a need for a wiring harness capable of withstanding the effects of ultraviolet light and other environmental factors without suffering the usual damage caused by constant exposure to these conditions.

### SUMMARY OF THE INVENTION

The present invention relates to an outdoor wiring harness that is protected from external environmental damage. The harness is designed to provide protection from the environmental factors and conditions to which it may be exposed, providing greater assurance that the items, such as wires and/or cables, contained within the harness are not detrimentally affected by such environmental factors and conditions. The harness may include a covering to protect the harness contents from rain, wind, and snow. The harness further protects the contents from ultraviolet light, which is beneficial for an outdoor wiring harness. Such ultraviolet protection may be accomplished by; for example, including ultraviolet stabilizers in the manufacture of the materials used to construct the harness.

Additionally, the harness may be constructed to minimize aesthetic impact. For example, the ultraviolet light protected harness may be molded with specific dimensions, such that it blends in with grout lines of masonry work, or such that it may be mounted against a building without creating unnatural shadows. In general, outdoor cabling comes in a limited variety of colors, and thus, on a lighter-colored building, steps may be taken to conceal the cabling within a lighter-colored wiring harness.

### DESCRIPTION OF THE DRAWINGS

The present invention is described with reference to the accompanying drawings, in which like reference characters reference like elements, and wherein:

FIG. 1 shows an exploded cross-sectional view of a wiring harness of the present invention;

FIG. 2 shows an assembled cross-sectional view of the wiring harness of FIG. 1; and

FIG. 3 shows a perspective view of the wiring harness of FIG. 1.

### DETAILED DESCRIPTION OF THE INVENTION

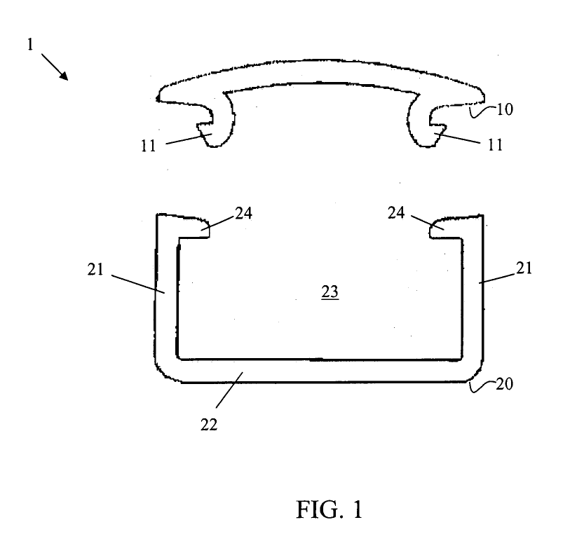

FIG. 1 shows an exploded cross-sectional view of a wiring harness 1 of the present invention. In one embodiment, the wiring harness 1 comprises two sections: an upper piece or cover 10 and a lower piece or trough 20. In the illustrated embodiment, the trough 20 has two side walls 21 extending upward from a bottom wall 22, thereby forming a volume 23 in which the contents to be protected, such as cables or wires (not shown), may be placed. While the side walls 21 are shown in the illustrated embodiment as being substantially perpendicular to the bottom wall 22, the side and bottom walls 21, 22 may be positioned at a variety of angles as desired. Similarly, additional walls may be used. Using a single bottom wall 22, however, helps ensure a good connection with the object, such as a building, to which the harness 1 is mounted. A substantially flat bottom wall 22 also helps ensure that no moisture, dirt, or other environmental material interferes with the connection between the harness 1 and the object to which the harness 1 is mounted. A substantially flat bottom wall 22 will also help to eliminate air gaps between the connecting surface and the surface of the object upon which the harness 1 is mounted. While this discussion has presumed that the outer surface of the bottom wall 22 will be the connecting surface, any surface of the harness 1 may be so used.

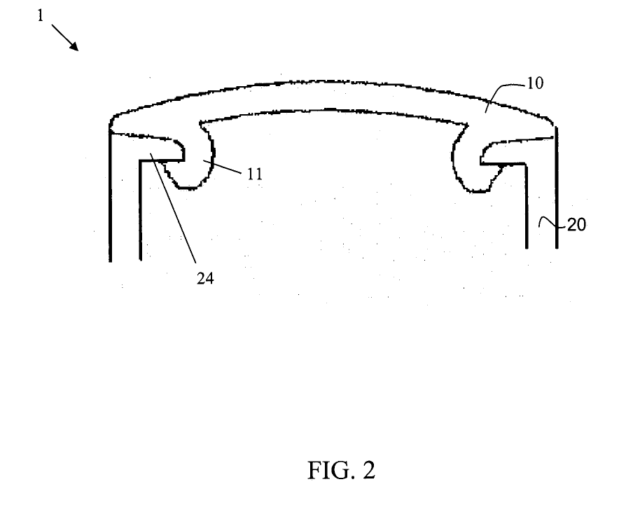

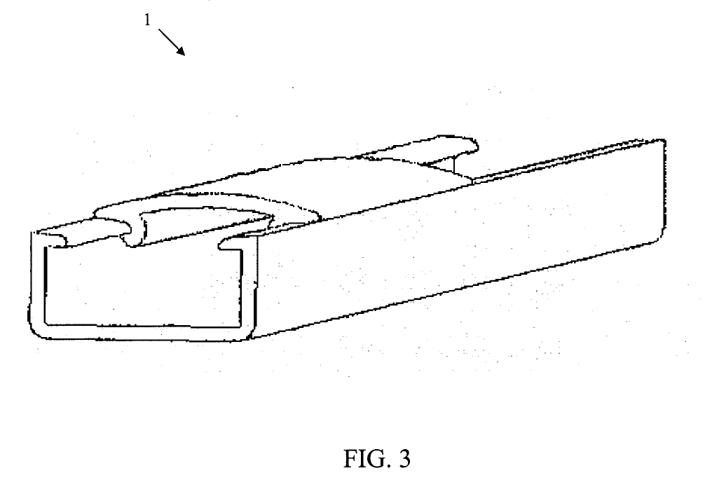

The side walls 21 of the trough 20 preferably each contain a notch 24 extending inward toward the interior volume 23. The cover 10 contains corresponding hooks 11 that extend downward away from its lower surface. The harness may be assembled by sliding the cover 10 onto the trough 20 such that the hooks 11 extend beneath the notches 24. Alternatively, the user can exert a force to elastically deform the hooks 11 and/or notches 24 such that the cover 10 is snapped onto the trough 20. This attachment may create a seal such that external contaminants, for example, water or dust, are prohibited from entering the interior volume 23. Preferably, the seal is water-tight. An assembled harness 1 is illustrated in FIGS. 2 and 3.

The harness 1 may be mounted to a building or other object in known fashion, such as via mechanical fasteners or an adhesive. Preferably, a flat surface of one of the walls 21, 22 is secured to the building. The harness 1 may be coupled to the building after it has been assembled, or one part, such as the trough 20, may be coupled to the building and the cover 10 later coupled to the trough 20.

Preferably, the harness components 10, 20 are manufactured such that they are resistant to damage caused by exposure to ultraviolet light. The manufacturing process may be accomplished in any of a number of ways familiar to one skilled in the art. On such exemplary process includes molding an appropriate thermoplastic or thermosetting material into the desired shapes of the components 10, 20. The resistance to damage caused by exposure to ultraviolet light may be accomplished, for example, by including an ultraviolet stabilizer in the creation of the plastic. Examples of such stabilizers that may be used include the Tinuvin line of products manufactured by Ciba, such as Tinuvin 328, Tinuvin 213, Tinuvin 765, Tinuvin 770, Tinuvin 622, and Tinuvin P.

According to another embodiment of the present invention, the harness 1 may be customized to minimize any adverse aesthetic impact upon an object to which it is mounted. For example, the profile may be contoured to minimize the creation of shadows, or its color may be chosen specifically to blend in with the object to which the harness 1 is attached.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

1. A harness, comprising an enclosure including a first body member and a second body member cooperatively defining an interior volume, and wherein the first and second body members are formed of a plastic material including an ultraviolet-resistant component.

2. The harness of claim 1, wherein said ultraviolet-resistant component is an ultraviolet stabilizer.

3. The harness of claim 1, wherein:
said first body member includes a hook; and
said second body member includes a notch that cooperatively with said hook forms a seal between said first and second body members.

4. The harness of claim 3, wherein said first body includes two hooks and said second body includes two notches.

5. The harness of claim 3, wherein said seal is water-tight.

6. The harness of claim 1, wherein at least one of said first and second body members contains a substantially flat outer connecting surface.

7. The harness of claim 6, wherein said connecting surface is designed to eliminate air gaps between said connecting surface and a second surface upon which the harness is mounted.

8. The wiring harness of claim 1, wherein said first and second body members are colored to match the surface upon which the harness is mounted.

9. The wiring harness of claim 1, wherein the edges of said first and second body members are designed to minimize a shadow they cast against a surface on which the harness is mounted.

10. The wiring harness of claim 3, wherein said hook and notch are arranged such that said first body member and said second body member may be coupled by positioning said hook below said notch and sliding said first body member relative to said second body member.
